(19) United States
(12) Patent Application Publication
(10) Pub. No.: US 2017/0131896 A1
(43) Pub. Date: May 11, 2017

(54) ELECTRONIC DEVICE AND METHOD FOR SELECTING AREA ASSOCIATED WITH CONTENT

(71) Applicant: Samsung Electronics Co., Ltd, Gyeonggi-do (KR)

(72) Inventors: Taegun Park, Gyeonggi-do (KR); Hyuk Kang, Gyeonggi-do (KR); Taeho Kim, Chungcheongbuk-do (KR); Hyesun Kim, Gyeonggi-do (KR); Heejun Kim, Seoul (KR); Jeongmin Park, Gyeonggi-do (KR); Jaeseok Joo, Gyeonggi-do (KR); Inji Jin, Gyeonggi-do (KR)

(21) Appl. No.: 15/348,960

(22) Filed: Nov. 10, 2016

(30) Foreign Application Priority Data
Nov. 10, 2015 (KR) 10-2015-0157290

(51) Int. Cl. G06F 3/0488; G06F 3/0482; G06F 3/0484

(52) U.S. Cl. CPC G06F 3/04883; G06F 3/04845; G06F 3/0482

(57) ABSTRACT

An electronic device and method for selecting an area of a content using pressure-sensitive touch technology. An embodiment for selecting an area of content using the pressure-sensitive technology includes displaying a content on a display, sensing user input on a region of the content being displayed, and measuring a level of pressure applied by the user input on the region. Then, in response to the measured level of pressure being a first value, selecting a first range of the content. However, in response to the measured level of pressure being a second value, selecting a second range of the content. Finally, displaying an indication to the selected first range or second range on the display. Selection of the first or second range may be on a basis of an attribute or property of an object in the region, and the selected range may be designated as a geofence area.

### CROSS-REFERENCE TO RELATED APPLICATION(S) AND CLAIM OF PRIORITY

The present application is related to and claims the benefit under 35 U.S.C. §119(a) of Korean patent application filed on Nov. 10, 2015 in the Korean Intellectual Property Office and assigned Serial number 10-2015-0157290, the entire disclosure of which is hereby incorporated by reference.

### TECHNICAL FIELD

Various embodiments of the present disclosure relate to a method for selecting an area associated with content and an electronic device supporting the same.

### BACKGROUND

Recently, electronic devices have a touchscreen, which may be used for both a display means and input means. With advances in touchscreen technologies, an electronic device may not only sense user input (e.g. finger touch, pen touch, pen hovering, hand hovering) but also sense multiple levels of pressure applied by user input. For example, the electronic device may differentiate between user input with a soft touch on the touchscreen and user input with a deep press on the touchscreen.

In the related art, to select an area (e.g. object) associated with content, an electronic device may select a touched area in response to touch input. To select multiple areas, the electronic device may have to receive multiple separate touch inputs. That is, it is necessary to perform one selection action to direct the electronic device to select a specific area. This may inconvenience the user wishing to select or deselect a desired area.

### SUMMARY

To address the above-discussed deficiencies, it is a primary object to provide a method that enables the user to optimally select and configure an area associated with content and an electronic device supporting the method.

In various embodiments of the present disclosure, the method may cause an area to be selected using a pressure-sensitive touch technology. The pressure-sensitive touch technology involves sensing multiple levels of pressure applied by touch input and performing different actions depending on the sensed level of pressure. In various embodiments of the present disclosure, by use of the pressure-sensitive touch technology, the electronic device may sense the level of pressure applied by touch input and select an area associated with content according to the sensed level of pressure. In particular, the electronic device may be configured by default to select an area in accordance with the attribute of an object corresponding to touch input of the user.

In various embodiments of the present disclosure, the electronic device may select an area associated with content according to the sensed level of pressure applied by touch input on the basis of the attribute of an object corresponding to the touch input. The electronic device may configure the selected area as a geofence area or may cause a specific application to select multiple objects in an easy manner.

The following detailed description focuses on, but is not limited to, configuring and changing a geofence area. In the present disclosure, upon detecting user input at a portion of content, a specific area containing an object corresponding to the user input may be selected. In addition, the level of pressure applied by the user input may be measured, the size of the selected area may be changed on the basis of the measured level of pressure, and a function associated with the object may be performed on the basis of the changed area.

In accordance with an embodiment of the present disclosure, there is provided an electronic device configured to select an area associated with content. The electronic device may include: a display to display a piece of content and to receive user input; a sensor to measure the level of pressure applied by user input; and a processor functionally connected with the display. The processor may be configured to perform a process of displaying a piece of content on the display, measuring the level of pressure applied by user input on a region of the content through the sensor, selecting, when the measured level of pressure is a first value, a first range of the content, selecting, when the measured level of pressure is a second value, a second range of the content, and displaying an indication to the selected one of the first range and the second range on the display.

In accordance with another embodiment of the present disclosure, there is provided a method for selecting an area associated with content. The method for an electronic device may include: displaying a piece of content on a display; sensing user input on a region of the content; measuring the level of pressure applied by the user input; selecting, when the measured level of pressure is a first value, a first range of the content; selecting, when the measured level of pressure is a second value, a second range of the content; and displaying an indication to the selected one of the first range and the second range on the display.

In accordance with another embodiment of the present disclosure, there is provided an electronic device configured to select an area associated with content. The electronic device may include: a display to display a piece of content and to receive user input; a sensor to measure the level of pressure applied by user input; and a processor functionally connected with the display. The processor may be configured to perform a process of displaying a piece of content on the display, measuring the level of pressure applied by user input on a region of the content through the sensor, selecting, when the measured level of pressure is a first value, a first range of the content on the basis of the attribute or property of an object in the region, selecting, when the measured level of pressure is a second value, a second range of the content on the basis of the attribute or property of an object in the region, and displaying an indication to the selected one of the first range and the second range on the display.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a network environment including electronic devices according to various embodiments of the present disclosure;

FIG. 2 is a block diagram of an electronic device according to various embodiments of the present disclosure;

FIG. 3 is a block diagram of a program module according to various embodiments of the present disclosure;

FIGS. 4A to 4D illustrate selection of an area associated with content according to various embodiments of the present disclosure;

FIGS. 5A and 5B illustrate setup of a geofence area corresponding to the level of pressure according to various embodiments of the present disclosure;

FIGS. 6A to 6C are flowcharts that illustrate procedures for changing an area selected on the basis of the level of pressure applied by user input according to various embodiments of the present disclosure;

FIG. 7 illustrates modification of a geofence area on the basis of the level of pressure applied by user input according to various embodiments of the present disclosure;

FIG. 8 illustrates modification of a geofence area by excluding an object designated as a restricted region according to various embodiments of the present disclosure;

FIG. 9 illustrates modification of a geofence area with respect to a building or place according to various embodiments of the present disclosure;

FIG. 10 illustrates modification of a geofence area with respect to the horizontal direction and vertical direction according to various embodiments of the present disclosure; and

FIGS. 11A to 11C illustrate configuration settings for an electronic device entering a geofence area according to various embodiments of the present disclosure.

### DETAILED DESCRIPTION

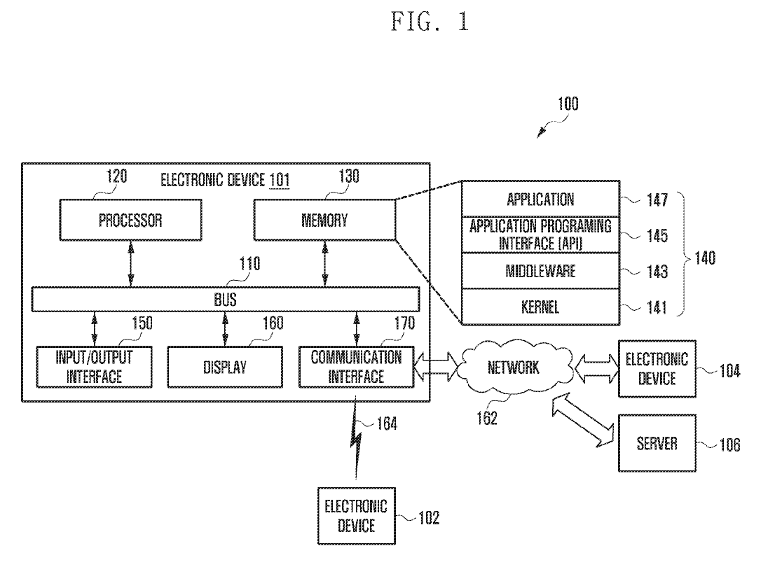

FIGS. 1 through 11C, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device.

Hereinafter, the present disclosure is described with reference to the accompanying drawings. Although specific embodiments are illustrated in the drawings and related detailed descriptions are discussed in the present specification, the present disclosure may have various modifications and several embodiments. However, various embodiments of the present disclosure are not limited to a specific implementation form and it should be understood that the present disclosure includes all changes and/or equivalents and substitutes included in the spirit and scope of various embodiments of the present disclosure. In connection with descriptions of the drawings, similar components are designated by the same reference numeral.

In various embodiments of the present disclosure, the terms such as “include”, “have”, “may include” or “may have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

In various embodiments of the present disclosure, the expression “or” or “at least one of A or/and B” includes any or all of combinations of words listed together. For example, the expression “A or B” or “at least A or/and B” may include A, may include B, or may include both A and B.

The expression “1”, “2”, “first”, or “second” used in various embodiments of the present disclosure may modify various components of the various embodiments but does not limit the corresponding components. For example, the above expressions do not limit the sequence and/or importance of the components. The expressions may be used for distinguishing one component from other components. For example, a first user device and a second user device indicate different user devices although both of them are user devices. For example, without departing from the scope of the present disclosure, a first structural element may be referred to as a second structural element. Similarly, the second structural element also may be referred to as the first structural element.

When it is stated that a component is “(operatively or communicatively) coupled to” or “connected to” another component, the component may be directly coupled or connected to another component or a new component may exist between the component and another component. In contrast, when it is stated that a component is “directly coupled to” or “directly connected to” another component, a new component does not exist between the component and another component. In the present disclosure, the expression “configured (or set) to do” may be used to be interchangeable with, for example, “suitable for doing,” “having the capacity to do,” “designed to do,” “adapted to do,” “made to do,” or “capable of doing.” The expression “configured (or set) to do” may not be used to refer to only something in hardware for which it is “specifically designed to do.” Instead, the expression “a device configured to do” may indicate that the device is “capable of doing” something with other devices or parts. For example, the expression “a processor configured (or set) to do A, B and C” may refer to a dedicated processor (e.g., an embedded processor) or a generic-purpose processor (e.g., CPU or application processor) that may execute one or more software programs stored in a memory device to perform corresponding functions.

An electronic device according to various embodiments of the present disclosure may be a device including an antenna. For example, the electronic device may be one or more of the following: a smart phone, a tablet Personal Computer (PC), a mobile phone, a video phone, an e-book reader, a desktop PC, a laptop PC, a netbook computer, a Personal Digital Assistant (PDA), Portable Multimedia Player (PMP), MP3 player, a mobile medical application, a camera, and a wearable device (for example, a Head-Mounted-Device (HMD), such as electronic glasses, electronic clothes, an electronic bracelet, an electronic necklace, an electronic appcessary, an electronic tattoo, and a smart watch).

According to some embodiments, the electronic device may be a smart home appliance having an antenna. The smart home appliance may include at least one of the following: a Television (TV), a Digital Video Disk (DVD) player, an audio player, an air conditioner, a cleaner, an oven, a microwave oven, a washing machine, an air purifier, a set-top box, a TV box (for example, Samsung HomeSync®, Apple TV®, or Google TV®, game consoles, an electronic dictionary, an electronic key, a camcorder, and an electronic frame.

According to some embodiments, the electronic device may include at least one of the following: various types of medical devices (for example, Magnetic Resonance Angiography (MRA), Magnetic Resonance Imaging (MRI), Computed Tomography (CT), a scanner, an ultrasonic device and the like), a navigation device, a Global Positioning System (GPS) receiver, an Event Data Recorder (EDR), a Flight Data Recorder (FDR), a vehicle infotainment device, electronic equipment for a ship (for example, a navigation device for ship, a gyro compass and the like), avionics, a security device, a head unit for a vehicle, an industrial or home robot, an Automatic Teller Machine (ATM) of financial institutions, and a Point Of Sale (POS) device of shops.

According to some embodiments, the electronic device may include at least one of the following: furniture or a part of a building/structure, an electronic board, an electronic signature receiving device, a projector, and various types of measuring devices (for example, a water meter, an electricity meter, a gas meter, a radio wave meter and the like), which are equipped with an antenna. The electronic device according to various embodiments of the present disclosure may also be a combination of the devices listed above. Further, the electronic device according to various embodiments of the present disclosure may be a flexible device. It is apparent to those skilled in the art that the electronic device according to various embodiments of the present disclosure is not limited to the above described devices.

Hereinafter, an electronic device according to various embodiments will be discussed with reference to the accompanying drawings. As used herein, the term “user” may indicate a person who uses an electronic device or a device (e.g., an artificial intelligence electronic device) that uses an electronic device.

In the description, the words “pressure-sensitive touch” indicate user input with pressure sensing, and the level of pressure may be sensed by a sensor of the electronic device. Here, user input may include direct touch input, (electronic) pen input, (electronic) pen hovering input, hand hovering input, or the like.

In addition, when a specific area is configured by the user as a geofence area, the “range of the geofence” may indicate the geofence area. The geofence area (or geofence range) may be widened or be narrowed.

FIG. 1 illustrates a network environment 100 including an electronic device 101 according to various embodiments of the present disclosure. The electronic device 101 may include a bus 110, a processor 120, a memory 130, an input/output interface 150, a display 160, and a communication interface 170. According to some embodiments, at least one of the above described components may be omitted from the electronic device 101 or another component may be further included in the electronic device 101.

The bus 110 may be a circuit connecting the above described components 120, 130, 150, 160, and 170, and transmitting communications (e.g., control messages and/or data) between the above described components.

The processor 120 may include one or more of the following: a central processing unit (CPU), an application processor (AP), and a communication processor (CP). The processor 120 is configured to control at least one of other components of the electronic device 101 and/or processing data or operations related to communication.

The memory 130 may include volatile memory and/or non-volatile memory. The memory 130 is configured to store data or commands related to at least one of other components of the electronic device 101. According to an embodiment, the memory 130 is configured to store software and/or a program module 140. For example, the program module 140 may include a kernel 141, middleware 143, application programming interface (API) 145, application programs (or applications) 147, etc. The kernel 141, middleware 143 or at least part of the API 145 may be called an operating system (OS).

The kernel 141 may control or manage system resources (e.g., the bus 110, processor 120, memory 130, etc.) used to execute operations or functions of other programs (e.g., the middleware 143, API 145, and application programs 147). The kernel 141 provides an interface for allowing the middleware 143, API 145, and application programs 147 to access and control/manage the individual components of the electronic device 101.

The middleware 143 is may mediate between the API 145 or application programs 147 and the kernel 141 so that the API 145 or the application programs 147 can communicate with the kernel 141 and exchange data therewith. The middleware 143 is configured to process one or more task requests received from the application programs 147 according to the priority. For example, the middleware 143 may assign a priority for use of system resources of the electronic device 101 (e.g., the bus 110, processor 120, memory 130, etc.) to at least one of the application programs 147. For example, the middleware 143 processes one or more task requests according to a priority assigned to at least one application program, thereby performing scheduling or load balancing for the task requests.

The API 145 refers to an interface configured to allow the application programs 147 to control functions provided by the kernel 141 or the middleware 143. The API 145 may include at least one interface or function (e.g., instructions) for file control, window control, image process, text control, or the like.

The input/output interface 150 configured to transfer instructions or data, received from the user or external devices, to one or more components of the electronic device 101. The input/output interface 150 is configured to output instructions or data, received from one or more components of the electronic device 101, to the user or external devices.

The display 160 may include a Liquid Crystal Display (LCD), a flexible display, a transparent display, a Light Emitting Diode (LED) display, an Organic Light Emitting Diode (OLED) display, Micro-Electro-Mechanical Systems (MEMS) display, an electronic paper display, etc. The display 160 is configured to display various types of content (e.g., texts, images, videos, icons, symbols, etc.). The display 160 may also be implemented with a touch screen. In this case, the display 160 is configured to receive touches, gestures, proximity inputs or hovering inputs, via a stylus pen, or a user's body.

The communication interface 170 is configured to establish communication between the electronic device 101 and an external device (e.g., a first external device 102, a second electronic device 104, or a server 106). For example, the communication interface 170 may communicate with an external device (e.g., a second external device 104 or a server 106) connected to the network 162 via wired or wireless communication.

Wireless communication may employ, as cellular communication protocol, at least one of the following: long-term evolution (LTE), LTE Advance (LTE-A), code division multiple access (CDMA), wideband CDMA (WCDMA), universal mobile telecommunications system (UMTS), Wireless Broadband (WiBro), and Global System for Mobile Communication (GSM). Wireless communication may also include short-wireless communication 164. Short-wireless communication 164 may include at least one of the following: wireless fidelity (WiFi), Bluetooth® (BT), near field communication (NFC), Magnetic Secure Transmission (MST), and Global Navigation Satellite System (GNSS). The GNSS may include at least one of the following: Global Positioning System (GPS), Global Navigation Satellite System (Glonass®), Beidou® Navigation Satellite System (hereinafter called ‘Beidou”), Galileo®, the European global satellite-based navigation system, according to GNSS using areas, bandwidths, etc. In the present disclosure, “GPS” and “GNSS” may be used interchangeably. Wired communication may include at least one of the following: universal serial bus (USB), high definition multimedia interface (HDMI), recommended standard 232 (RS-232), and plain old telephone service (POTS). The network 162 may include at least one of the following: a telecommunications network, e.g., a computer network (e.g., LAN or WAN), the Internet, and a telephone network.

The first and second external electronic devices 102 and 104 are each identical to or different from the electronic device 101, in terms of type. According to an embodiment, the server 106 may include a group of one or more servers. According to various embodiments, part or all of the operations executed on the electronic device 101 may be executed on another electronic device or a plurality of other electronic devices (e.g., electronic devices 102 and 104 or a server 106). According to an embodiment, when the electronic device needs to perform a function or service automatically or according to a request, and the electronic device does not perform the function or service, the electronic device may request at least part of the function related to the function or service from another electronic device (e.g., electronic devices 102 and 104 or a server 106). The other electronic device (e.g., electronic devices 102 and 104 or a server 106) is configured to execute the requested function or additional functions, and transmit the result to the electronic device 101. The electronic device 101 processes the received result, or further proceeds with additional processes, to provide the requested function or service. To this end, the electronic device 101 may employ cloud computing, distributed computing, or client-server computing technology.

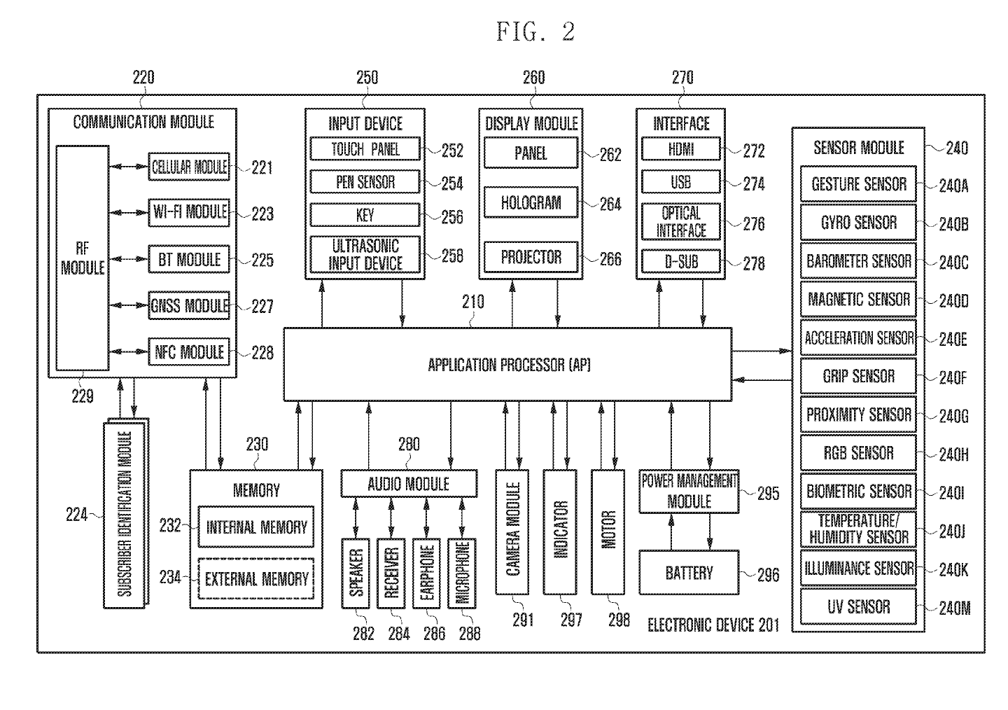

FIG. 2 is a detailed block diagram showing a configuration of an electronic device 201 according to various embodiments of the present disclosure. For example, the electronic device 201 may include part or all of the components in the electronic device 101 shown in FIG. 1. The electronic device 201 may include one or more processors 210 (e.g., Application Processors (APs)), a communication module 220, a Subscriber Identification Module (SIM) 224, a memory 230, a sensor module 240, an input device 250, a display 260, an interface 270, an audio module 280, a camera module 291, a power management module 295, a battery 296, an indicator 297, and a motor 298.

The processor 210 is configured to drive, for example, an operating system or an application program to control a plurality of hardware or software components connected to the processor 210, process various data, and perform operations. The processor 210 may be implemented as, for example, a System on Chip (SoC). According to an embodiment, the processor 210 may further include a graphic processing unit (GPU) and/or an image signal processor. The processor 210 may also include at least part of the components shown in FIG. 2, e.g., a cellular module 221. The processor 210 is configured to load commands or data received from at least one of other components (e.g., a non-volatile memory) on a volatile memory, process the loaded commands or data. The processor 210 is configured to store various data in a non-volatile memory.

The communication module 220 may include the same or similar configurations as the communication interface 170 shown in FIG. 1. For example, the communication module 170 may include a cellular module 221, WiFi module 223, Bluetooth® (BT) module 225, GNSS module 227 (e.g., a GPS module, Glonass® module, Beidou® module or Galileo® module), NFC module 228, and Radio Frequency (RF) module 229.

The cellular module 221 is configured to provide a voice call, a video call, an SMS service, an Internet service, etc., through a communication network, for example. According to an embodiment, the cellular module 221 is configured to identify and authenticate an electronic device 201 in a communication network by using a subscriber identification module (SIM) 224 (e.g., a SIM card). According to an embodiment, the cellular module 221 is configured to perform at least part of the functions provided by the processor 210. According to an embodiment, the cellular module 1721 may also include a communication processor (CP).

Each of the WiFi module 223, the BT module 225, the GNSS module 227, and the NFC module 228 may include a processor for processing data transmitted or received through the corresponding module. According to embodiments, at least part of the cellular module 221, WiFi module 223, BT module 225, GNSS module 227, and NFC module 228 (e.g., two or more modules) may be included in one integrated chip (IC) or one IC package.

The RF module 229 is configured for transmitting or receiving communication signals, e.g., RF signals. The RF module 229 may include a transceiver, a power amp module (PAM), a frequency filter, a low noise amplifier (LNA), an antenna, etc. According to another embodiment, at least one of the following modules: cellular module 221, WiFi module 223, BT module 225, GNSS module 227, and NFC module 228 is configured to transmit and receive RF signals through a separate RF module.

The SIM module 224 may include a card including a subscriber identification module (SIM) and/or an embodied SIM. The SIM module 224 is configured to contain unique identification information, e.g., integrated circuit card identifier (ICCID), or subscriber information, e.g., international mobile subscriber identity (IMSI).

The memory 230 (e.g., memory 130 shown in FIG. 1) may include a built-in memory 232 or an external memory 234. The built-in memory 232 may include at least one of the following: a volatile memory, e.g., a dynamic RAM (DRAM), a static RAM (SRAM), a synchronous dynamic RAM (SDRAM), etc.; and a non-volatile memory, e.g., a one-time programmable ROM (OTPROM), a programmable ROM (PROM), an erasable and programmable ROM (EPROM), an electrically erasable and programmable ROM (EEPROM), a mask ROM, a flash ROM, a flash memory (e.g., a NAND flash memory, an NOR flash memory, etc.), a hard drive, a solid state drive (SSD), etc.

The external memory 234 may also include a flash drive, e.g., a compact flash (CF), a secure digital (SD), a micro secure digital (Micro-SD), a mini secure digital (Mini-SD), an extreme digital (xD), a multi-media card (MMC), a memory stick, etc. The external memory 234 may be connected to the electronic device 201, functionally and/or physically, through various interfaces.

In various embodiments, the memory 230 may store at least one reference value for the level of pressure corresponding to user input. The processor 210 may use the sensor module 240 to measure the level of pressure corresponding to user input and compare the measured level of pressure with the reference value stored in the memory 230. The processor 210 may perform object selection differently according to the comparison result. In one embodiment, multiple reference values may be defined and stored in the memory 230. The processor 210 may perform object selection differently on the basis of the reference value matching the measured level of pressure.

In various embodiments, it is possible to store information about attributes and properties of one or more objects included in the content displayed on the display module 260. To configure an area corresponding to user input, the processor 210 of the electronic device may configure an area on the basis of such information about attributes and properties. For example, if attribute information of the object associated with user input indicates a building, the processor 210 may designate multiple buildings having the same attribute as the object as a specific area.

The sensor module 240 is configured for measuring/detecting a physical quantity or an operation state of the electronic device 201, and converting the measured or detected information into an electronic signal. The sensor module 240 may include at least one of the following: a gesture sensor 240A, a gyro sensor 240B, an atmospheric pressure sensor 240C, a magnetic sensor 240D, an acceleration sensor 240E, a grip sensor 240F, a proximity sensor 240G, a color sensor 240H (e.g., a red, green and blue (RGB) sensor), a biometric sensor 240I, a temperature/humidity sensor 240J, an illuminance sensor 240K, and a ultraviolet (UV) sensor 240M. Additionally or alternatively, the sensor module 240 may further include an E-nose sensor, an electromyography (EMG) sensor, an electroencephalogram (EEG) sensor, an electrocardiogram (ECG) sensor, an infrared (IR) sensor, an iris sensor and/or a fingerprint sensor. The sensor module 240 may further include a control circuit for controlling one or more sensors included therein. In embodiments, the electronic device 201 may include a processor, configured as part of the processor 210 or a separate component, for controlling the sensor module 240. In this case, while the processor 210 is operating in sleep mode, the processor is configured to control the sensor module 240. In one embodiment, the electronic device may further include, as part of the processor 210 or as a separate entity, a controller configured to control the sensor module 240. The controller may control the sensor module 240 while the processor 210 remains in the sleep state. The sensor module 240 may include a pressure sensor (not shown), which is used to measure the level of pressure applied by user input.

The input device 250 may include a touch panel 252, a (digital) pen sensor 254, a key 256, or an ultrasonic input unit 258. The touch panel 252 may be implemented with at least one of the following: a capacitive touch system, a resistive touch system, an infrared touch system, and an ultrasonic touch system. The touch panel 252 may further include a control circuit. The touch panel 252 may also further include a tactile layer to provide a tactile response to the user.

The (digital) pen sensor 254 may be implemented with a part of the touch panel or with a separate recognition sheet. The key 256 may include a physical button, an optical key, or a keypad. The ultrasonic input unit 258 is configured to detect ultrasonic waves created in an input tool, through a microphone 288, and identify data corresponding to the detected ultrasonic waves.

The display 260 (e.g., the display 160 shown in FIG. 1) may include a panel 262, a hologram unit 264, or a projector 266. The panel 262 may include the same or similar configurations as the display 160 shown in FIG. 1. The panel 262 may be implemented to be flexible, transparent, or wearable. The panel 262 may also be incorporated into one module together with the touch panel 252. The hologram unit 264 is configured to show a stereoscopic image in the air by using light interference. The projector 266 is configured to display an image by projecting light onto a screen. The screen may be located inside or outside of the electronic device 201. According to an embodiment, the display 260 may further include a control circuit for controlling the panel 262, the hologram unit 264, or the projector 266.

The interface 270 may include a high-definition multimedia interface (HDMI) 272, a universal serial bus (USB) 274, an optical interface 276, or a D-subminiature (D-sub) 278. The interface 270 may be included in the communication interface 170 shown in FIG. 1. Additionally or alternatively, the interface 270 may include a mobile high-definition link (MHL) interface, a secure digital (SD) card/multimedia card (MMC) interface, or an infrared data association (IrDA) standard interface.

The audio module 280 is configured to provide bidirectional conversion between a sound and an electronic signal. At least part of the components in the audio module 280 may be included in the input/output interface 150 shown in FIG. 1. The audio module 280 is configured to process sound information input or output through a speaker 282, a receiver 284, earphones 286, microphone 288, etc.

The camera module 291 refers to a device configured to take both still and moving images. According to an embodiment, the camera module 291 may include one or more image sensors (e.g., a front image sensor or a rear image sensor), a lens, an image signal processor (ISP), a flash (e.g., an LED or xenon lamp), etc.

The power management module 295 is configured to manage power of the electronic device 201. According to an embodiment, the power management module 295 may include a power management integrated circuit (PMIC), a charger IC, or a battery or fuel gauge. The PMIC may employ wired charging and/or wireless charging methods. Examples of the wireless charging method are magnetic resonance charging, magnetic induction charging, and electromagnetic charging. To this end, the PIMC may further include an additional circuit for wireless charging, such as a coil loop, a resonance circuit, a rectifier, etc. The battery gauge is configured to measure the residual capacity, charge in voltage, current, or temperature of the battery 296. The battery 296 takes the form of either a rechargeable battery or a solar battery.

The indicator 297 is configured to display a specific status of the electronic device 201 or a part thereof (e.g., the processor 210), e.g., a boot-up status, a message status, a charging status, etc. The motor 298 is configured to convert an electrical signal into mechanical vibrations, such as, a vibration effect, a haptic effect, etc. Although not shown, the electronic device 201 may further include a processing unit (e.g., GPU) for supporting a mobile TV. The processing unit for supporting a mobile TV is configured to process media data pursuant to standards, e.g., digital multimedia broadcasting (DMB), digital video broadcasting (DVB), or mediaFlo®, etc.

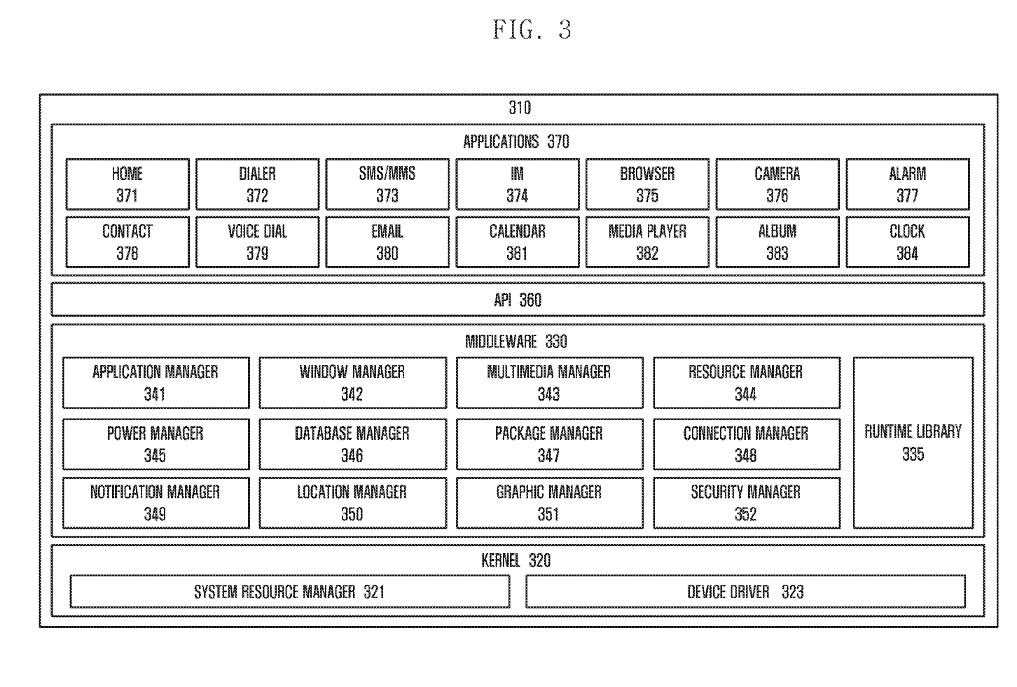

FIG. 3 is a block diagram of a programming module according to various embodiments. According to an embodiment, the program module 310 (e.g., program module 140 shown in FIG. 1) may include an operation system (OS) for controlling resources related to the electronic device (e.g., electronic device 101) and/or various applications (e.g., application programs 147 shown in FIG. 1) running on the OS. The OS may be Android®, iOS®, Windows®, Symbian®, Tizen®, Bada®, etc.

The program module 310 may include a kernel 320, middleware 330, application programming interface (API) 360 and/or applications 370. At least part of the program module 310 may be preloaded on the electronic device or downloaded from a server (e.g., an electronic device 102 or 104, server 106, etc.).

The kernel 320 (for example, kernel 141) may include a system resource manager 321 and/or a device driver 323. The system resource manager 321 may include, for example, a process manager, a memory manager, and a file system manager. The system resource manager 321 may perform a system resource control, allocation, and recall. The device driver 323 may include, for example, a display driver, a camera driver, a Bluetooth® driver, a shared memory driver, a USB driver, a keypad driver, a WiFi driver, and an audio driver. Further, according to an embodiment, the device driver 323 may include an Inter-Process Communication (IPC) driver.

The middleware 330 may provide a function required in common by the applications 370. Further, the middleware 330 may provide a function through the API 360 to allow the applications 370 to efficiently use limited system resources within the electronic device. According to an embodiment, the middleware 330 (for example, the middleware 143) may include at least one of a runtime library 335, an application manager 341, a window manager 342, a multimedia manager 343, a resource manager 344, a power manager 345, a database manager 346, a package manager 347, a connection manager 348, a notification manager 349, a location manager 350, a graphic manager 351, and a security manager 352.

The runtime library 335 may include, for example, a library module used by a compiler to add a new function through a programming language while the applications 370 are executed. According to an embodiment, the runtime library 335 executes input and output, management of a memory, a function associated with an arithmetic function and the like.

The application manager 341 may manage, for example, a life cycle of at least one of the applications 370. The window manager 342 may manage GUI resources used on the screen. The multimedia manager 343 may detect a format required for reproducing various media files and perform an encoding or a decoding of a media file by using a codec suitable for the corresponding format. The resource manager 344 manages resources such as a source code, a memory, or a storage space of at least one of the applications 370.

The power manager 345 may operate together with a Basic Input/Output System (BIOS) to manage a battery or power and provides power information required for the operation. The database manager 346 may manage generation, search, and change of a database to be used by at least one of the applications 370. The package manager 347 may manage an installation or an update of an application distributed in a form of a package file.

The connection manager 348 may manage, for example, a wireless connection such as WiFi or Bluetooth®. The notification manager 349 may display or notify a user of an event such as an arrival message, an appointment, a proximity alarm or the like, in a manner that does not disturb the user. The location manager 350 may manage location information of the electronic device. The graphic manager 351 may manage a graphic effect provided to the user or a user interface related to the graphic effect. The security manager 352 provides a general security function required for a system security or a user authentication. According to an embodiment, when the electronic device (for example, the electronic device 101) has a call function, the middleware 330 may further include a telephony manager for managing a voice of the electronic device or a video call function.

The middleware 330 may include modules configuring various combinations of functions of the above described components. The middleware 330 is configured to provide modules, specialized according to types of operation systems, to provide distinct functions. The middleware 330 may be adaptively configured in such a way as to remove part of the existing components or to include new components.

The API 360 (for example, API 145) may be a set of API programming functions, and may be provided with a different configuration according to an operating system. For example, in Android® or iOS®, a single API set may be provided for each platform. In Tizen®, two or more API sets may be provided.

The applications 370 (e.g., application programs 147) may include one or more applications for performing various functions, e.g., home 371, diary 372, SMS/MMS 373, instant message (IM) 374, browser 375, camera 376, alarm 377, contact 378, voice dial 379, email 380, calendar 381, media player 382, album 383, clock 384, health care (e.g., an application for measuring amount of exercise, blood sugar level, etc.), and environment information (e.g., an application for providing atmospheric pressure, humidity, temperature, etc.).

According to an embodiment, the applications 370 may include an application for supporting information exchange between an electronic device (e.g., electronic device 101) and an external device (e.g., electronic devices 102 and 104), which is hereafter called ‘information exchange application’). The information exchange application may include a notification relay application for relaying specific information to external devices or a device management application for managing external devices.

For example, the notification relay application may include a function for relaying notification information, created in other applications of the electronic device (e.g., SMS/MMS application, email application, health care application, environment information application, etc.) to external devices (e.g., electronic devices 102 and 104). In addition, the notification relay application is configured to receive notification information from external devices and to provide the received information to the user.

The device management application is configured to manage (e.g., install, remove, or update) at least one function of an external device (e.g., electronic devices 102 and 104) communicating with the electronic device. Examples of the function are a function of turning-on/off the external device or part of the external device, a function of controlling the brightness (or resolution) of the display, applications running on the external device, services provided by the external device, etc. Examples of the services are a call service, messaging service, etc.

According to an embodiment, the applications 370 may include an application (e.g., a health care application of a mobile medical device, etc.) specified attributes of an external device (e.g., electronic devices 102 and 104). According to an embodiment, the applications 370 may include applications received from an external device (e.g., a server 106, electronic devices 102 and 104). According to an embodiment, the applications 370 may include a preloaded application or third party applications that can be downloaded from a server. It should be understood that the components of the program module 310 may be called different names according to types of operating systems.

According to various embodiments, at least part of the program module 310 can be implemented with software, firmware, hardware, or any combination of two or more of them. At least part of the program module 310 can be implemented (e.g., executed) by a processor (e.g., processor 210). At least part of the programming module 310 may include modules, programs, routines, sets of instructions or processes, etc., in order to perform one or more functions.

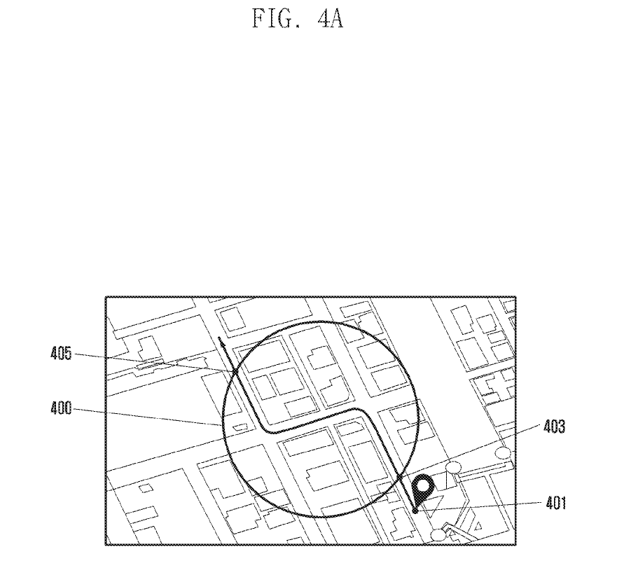

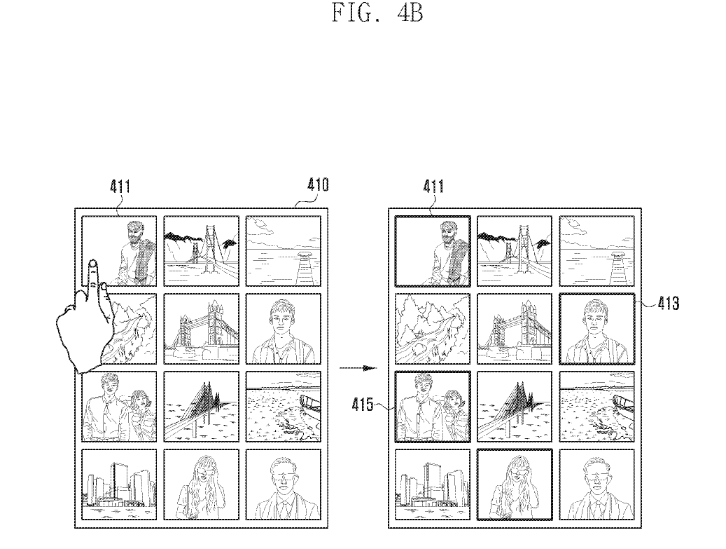

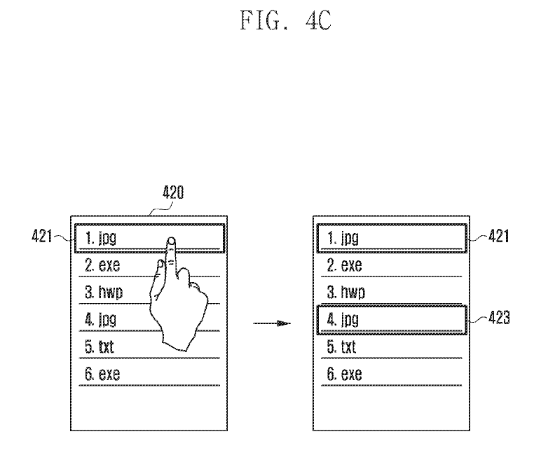

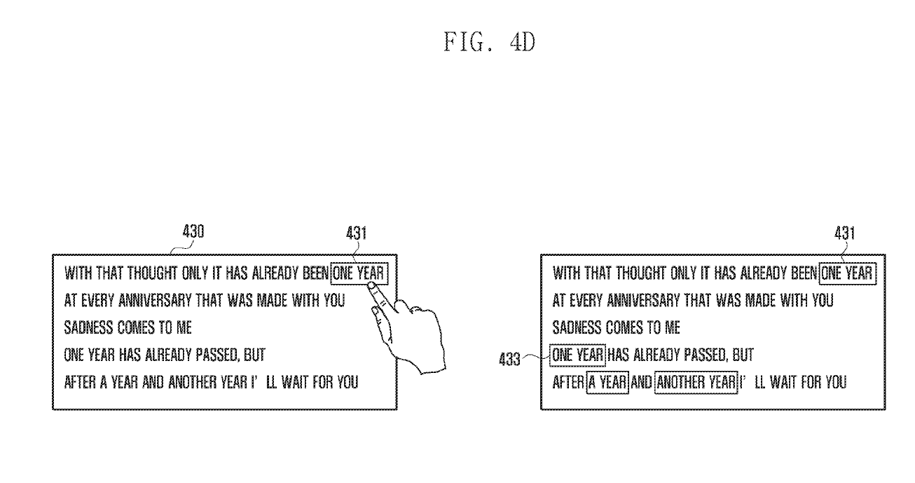

FIGS. 4A to 4D illustrate selection of an area associated with content according to various embodiments of the present disclosure.

FIG. 4A shows an example where, when the content is a map application, a region in the map is selected and configured as a geofence area. As shown in FIG. 4A, the electronic device 201 (e.g. processor 210) of FIG. 2 may designate a region on the map as a geofence area 400. Here, the geofence area 400 may correspond to a virtual perimeter for a geographic area, and may be used to track another electronic device (e.g. specific user) entering or exiting a specific area of interest. The electronic device 201 may monitor other electronic devices entering or leaving the geofence area 400 or may notify occurrence of an entrance event or exit event in association with the geofence area 400.

To configure a geofence area, it is necessary to acquire precise location information. GPS-based schemes are used to acquire general and accurate location information. However, GPS-based acquisition may cause excessive battery consumption due to continuous location measurement and may fail to deliver accurate location information in indoor or shadow areas where satellite signals are blocked. As such, advanced positioning schemes may utilize not only GPS signals but also signals or information from nearby base stations and Wi-Fi access points to measure and correct location information.

In various embodiments, the electronic device 201 may monitor when a second electronic device 401 enters the geofence area 400 (as indicated by indicia 403) or leaves the geofence area 400 (as indicated by indicia 405). That is, the electronic device 201 may tract the location of the second electronic device 401 around the geofence area 400. For example, to prevent the second electronic device 401 from entering a specific area, the electronic device 201 may configure the specific area as a geofence area 400 and monitor the second electronic device 401 whether it enters or leaves the geofence area 400. The electronic device 201 may be notified when the second electronic device 401 enters the geofence area 400 as indicated by indicia 403. The electronic device 201 may also be notified when the second electronic device 401 leaves the geofence area 400 as indicated by indicia 405. In other words, the electronic device 201 may configure a specific region on the map as a geofence area and monitor other electronic devices entering or exiting the geofence area.

In various embodiments, the electronic device may execute a map application to display a map on the screen. The electronic device may sense user input corresponding to an object on the map and measure the level of pressure applied by the user input. When the measured level of pressure is higher than the reference value, the electronic device may configure or modify a geofence area on the basis of the attribute or property of the object corresponding to the user input.

FIG. 4B illustrates a screen 410 of the electronic device 201 when the content is a gallery application handling photographs. When the gallery application is initiated, the processor 210 of the electronic device 201 may display one or more photographs as thumbnails. Here, thumbnails are used only to cite an instance of a display scheme, and the description is not limited to thumbnails. Thereafter, the processor 210 may sense user input for selecting a first thumbnail 411 from among the thumbnails. The processor 210 may measure the level of pressure applied by the user input and determine whether the measured level of pressure is higher than the first reference value. If the measured level of pressure is higher than the first reference value, the processor 210 may examine the attribute or property of the first thumbnail 411 and further select a second thumbnail 413 and third thumbnail 415 having the same attribute or property as the first thumbnail 411. Here, the attribute or property of a photograph may indicate the genre (portrait, still life, or landscape) of the photograph, and the location, date, and time at which the photograph was taken. That is, when user input for selecting a first thumbnail 411 being a portrait photograph is sensed and the level of pressure applied by the user input is higher than the first reference value, the processor 210 may further select multiple thumbnails having the same attribute or property as the first thumbnail 411. Alternatively, the processor 210 may additionally select different thumbnails (photographs) containing the same person as the first thumbnail 411. Although not shown, it is possible to set a second reference value, and the processor 210 may select all thumbnails (photographs) when the level of pressure applied by user input is higher than the second reference value. When one or more reference values are set, the processor 210 may perform different operations for the individual reference values.

As described above, when a gallery application is initiated to display photographs, the electronic device may sense user input for selecting a particular photograph among the displayed photographs and measure the level of pressure applied by the user input. If the level of pressure is higher than the reference value, the electronic device may select one or more photographs having the same attribute or property on the basis of the attribute or property of the already selected photograph.

FIG. 4C illustrates a screen 420 of the electronic device 201 when the content is a file manager application. When the file manager application is executed, the processor 210 of the electronic device 201 may display a list of files. Thereafter, the processor 210 may sense user input for selecting a first file 421 from the list. The processor 210 may measure the level of pressure applied by the user input and determine whether the measured level of pressure is higher than the first reference value. If the measured level of pressure is higher than the first reference value, the processor 210 may examine the attribute or property (e.g. location or type) of the first file 421 and further select a second file 423 having the same type as the first file 421. Here, both the first file 421 and the second file 423 have an extension “jpg” indicating a photograph file. That is, when user input for selecting a first file is sensed, the processor 210 may further select other files having the same type as the first file on the basis of the level of pressure applied by the user input. In addition, it is possible to set a second reference value, and the processor 210 may select all photograph files when the level of pressure applied by user input is higher than the second reference value. Here, photograph files may have extensions for image files such as “jpg”, “jpeg”, “gif”, “png”, and “bmp”.

As described above, when a file manager application is initiated to display a list of files, the electronic device may sense user input for selecting a particular file from the list and measure the level of pressure applied by the user input. If the level of pressure is higher than the reference value, the electronic device may select one or more files having the same attribute or property on the basis of the attribute or property of the already selected file.

FIG. 4D illustrates a screen 430 of the electronic device 201 when the content is a text editing application. When the text editing application is executed, the processor 210 of the electronic device 201 may display a specific document on the screen (e.g. display module 260). The processor 210 may sense user input for selecting a first term 431 among words of the document. The processor 210 may measure the level of pressure applied by the user input and determine whether the measured level of pressure is higher than the first reference value. If the measured level of pressure is higher than the first reference value, the processor 210 may examine the attribute or property of the first term 431 and further select a second term 433 having the same attribute or property as the first term 431. In FIG. 4D, in addition to the first term 431, the second term 433 having the same meaning as the first term 431 is selected. The attribute or property of a term (word or phrase) may indicate the meaning, character, speaker, chapter, or the like. In addition, it is possible to set a second reference value, and the processor 210 may select sentences or paragraphs containing the first term 431 when the level of pressure applied by user input is higher than the second reference value. When one or more reference values are set, the processor 210 may perform different operations for the individual reference values.

As described above, when a text editing application is initiated to display a document of words or sentences, the electronic device may sense user input for selecting a particular term from the document and measure the level of pressure applied by the user input. If the level of pressure is higher than the reference value, the electronic device may select one or more terms having the same attribute or property on the basis of the attribute or property of the already selected term.

Next, a description is given of configuring a geofence area using, but not limited to, a map application, as an embodiment of the present disclosure.

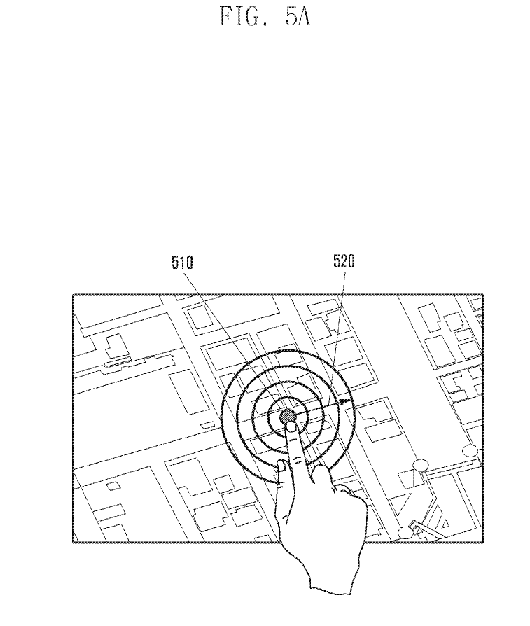

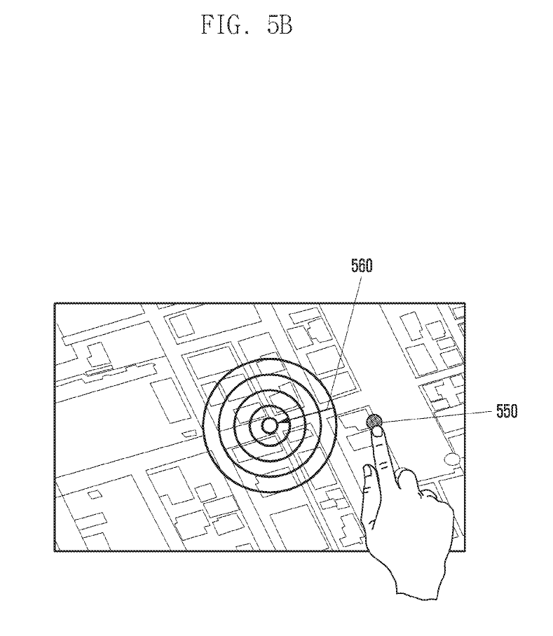

FIGS. 5A and 5B illustrate setup of a geofence area in accordance with the level of pressure applied by user input.

In FIG. 5A, the processor 210 of the electronic device 201 may display content (e.g. map, gallery, file manager) containing one or more objects. The processor 210 may sense user input 510 (e.g. hand touch, pen touch, hand hovering, pen hovering) and may enlarge a region of the content (e.g. geofence area) in accordance with the user input 510 as indicated by indicia 520. For example, the processor 210 may measure the level of pressure applied by the user input 510. A reference value for the level of pressure may be pre-stored in the memory 230. The measured level of pressure may be subdivided on the basis of the reference value. The processor 210 may measure the level of pressure applied by the user input 510, compare the measured level of pressure with the reference value stored in the memory 230, and determine the size of the geofence area according to the comparison result. For example, the processor 210 may gradually increase the size of the geofence area with the increasing level of pressure. The processor 210 may also determine the speed of expansion of the geofence area on the basis of the measured level of pressure. For example, the processor 210 may increase the speed of expansion of the geofence area with the increasing level of pressure. Alternatively, the processor 210 may determine the speed of expansion of the geofence area according to the time required for the increasing level of pressure to reach the reference value. In FIG. 5A, although the user input 510 is sensed at the center of the geofence area, user input is not limited thereat.

Referring to FIG. 5B, the processor 210 of the electronic device 201 may sense user input 550 outside the geofence area. Upon sensing the user input 550 outside the geofence area, the processor 210 may reduce the size of the geofence area on the basis of the sensed user input 550 as indicated by indicia 560. For example, the processor 210 may measure the level of pressure applied by the user input 550. A reference value for the level of pressure may be pre-stored in the memory 230. The memory 230 may pre-store more than one reference value. The measured level of pressure may be subdivided on the basis of the reference value. The processor 210 may measure the level of pressure applied by the user input 550, compare the measured level of pressure with the reference value stored in the memory 230, and determine the size of the geofence area according to the comparison result. For example, the processor 210 may gradually decrease the size of the geofence area with the increasing level of pressure. The processor 210 may also determine the speed of reduction of the geofence area on the basis of the measured level of pressure. For example, the processor 210 may increase the speed of reduction of the geofence area with the increasing level of pressure. Alternatively, the processor 210 may determine the speed of reduction of the geofence area according to the time required for the increasing level of pressure to reach the reference value. In FIG. 5B, although the user input 550 is sensed at a place outside the geofence area, user input is not limited thereat.

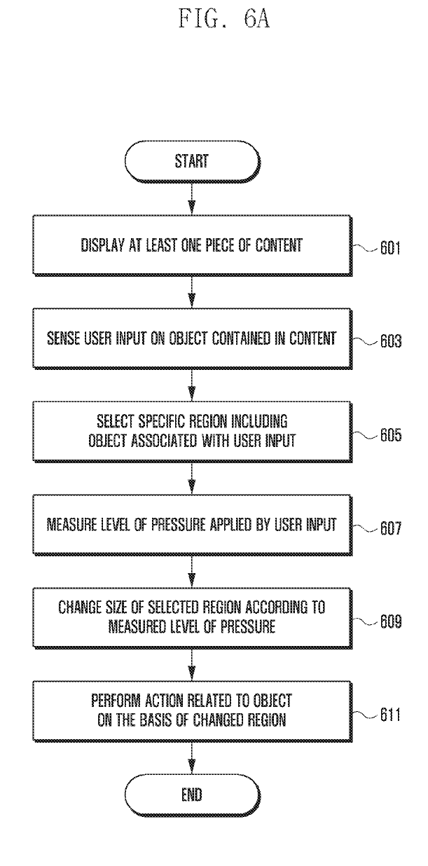

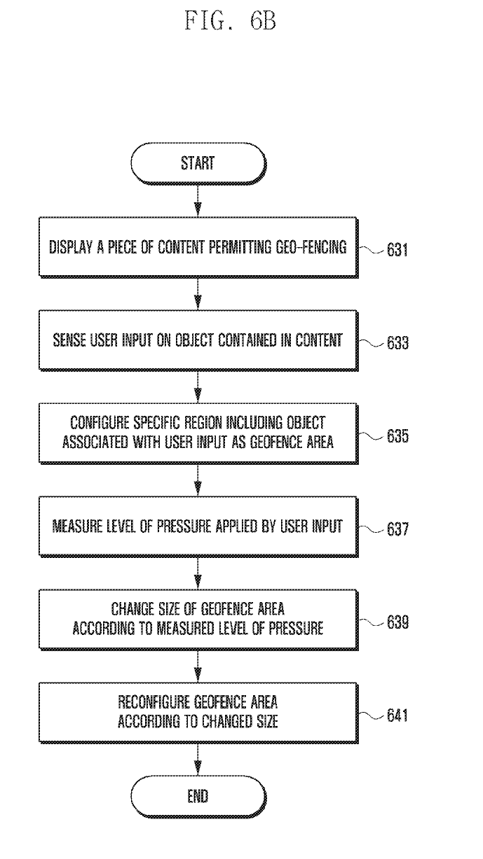

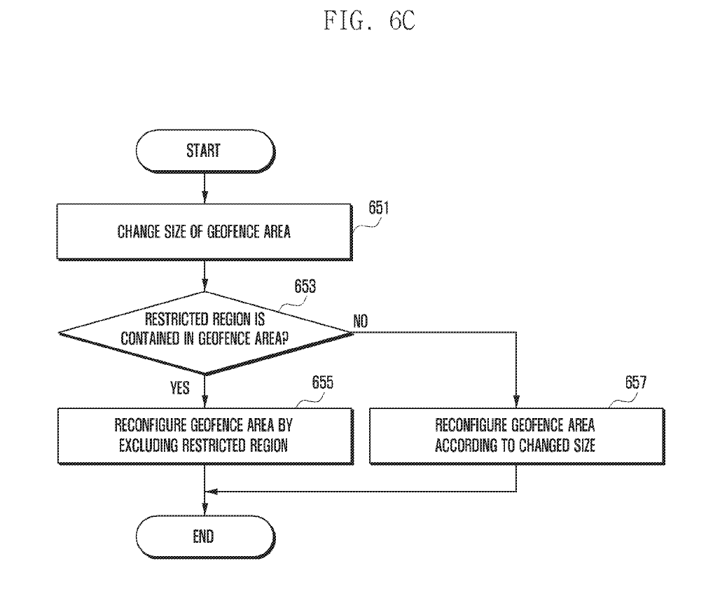

FIGS. 6A to 6C are a flowchart of a procedure for changing a selected area on the basis of the level of pressure applied by user input.

Referring to FIG. 6A, at operation 601, the processor 210 of the electronic device 201 displays at least one piece of content on the display module 260. The content may include one or more objects. For example, when a map application is executed as a piece of content, the processor 210 may display objects (e.g. building, road, river, and park) on the map. Objects may be categorized or grouped according to their attributes. The processor 210 may identify an object on the basis of the attribute. As shown in FIGS. 4A to 4D, the present disclosure may be applied not only to a map application but also to a gallery application, file manager application, and a document handling application. For ease of description, the following description focuses on, but not limited to, utilization of a map application.

At operation 603, the processor 210 senses user input on an object of the content. Here, user input may include finger touch, pen touch, pen hovering, and hand hovering. The processor 210 may sense user input on at least one object in display.

At operation 605, the processor 210 selects a specific region including the object associated with the user input. Here, the region may be selected on the basis of the attribute or category of the object or the attribute of objects around the object associated with the user input. For example, when user input is sensed at a specific building on the map, the processor 210 may select a region on the basis of the boundary line of the building. The processor 210 may also select a region on the basis of the roads around the building.

At operation 607, the processor 210 measures the level of pressure applied by the user input. The electronic device 201 may include the panel 262 of the display module 260 and the touch panel 252 of the input unit 250. The electronic device 201 may also include a pressure sensor to measure the level of pressure applied by user input. Upon sensing user input, the processor 210 may use the pressure sensor to measure the level of pressure applied by the user input. For example, the processor 210 may identify the x and y coordinates of the user input and identify the z coordinate (i.e. the level of applied pressure) of the user input through the pressure sensor. The processor 210 may measure the level of pressure applied by user input on the basis of the x, y and z coordinates and may distinguish between a light press and a deep press on the basis of the measured level of pressure.

At operation 609, the processor 210 changes the size of the selected region according to the measured level of pressure. The memory 230 may pre-store at least one reference value. The processor 210 may compare the measured level of pressure with the reference value and change the size of the selected region. For example, when a first reference value and a second reference value are pre-stored, if the measured level of pressure is higher than the first reference value, the processor 210 may change the selected region to a first-sized region. If the measured level of pressure is higher than the second reference value, the processor 210 may change the selected region to a second-sized region. That is, the electronic device 201 may measure the level of pressure applied by user input and determine the size of a selected region on the basis of the measured level of pressure.

At operation 611, the processor 210 performs an action related to the object on the basis of the changed region. For example, in a map application, when an object (e.g. building) is selected, the processor 210 may configure a specific region containing the object as a geofence area. As another example, in a media application, when an object (e.g. media file) is selected, the processor 210 may bookmark objects having the same attribute as the selected object or may play back the selected object.

In the present disclosure, when a piece of content is displayed on the screen, user input may be sensed on at least one object (e.g. map object, media file, image object, or application object). Upon sensing of user input, a specific region containing the selected object may be selected. The level of pressure applied by the user input may also be measured. The size of the selected region may be changed according to the measured level of pressure. Changing the size of the selected region may indicate changing the selected region on the basis of an object having an attribute similar to that of the selected object. Thereafter, a specific function related to the selected object may be performed on the basis of the changed region. For example, a geofence may be set up around the selected object in the case of a map application. When the selected object is a media file, the media file may be bookmarked. When multiple files or applications are selected, they may be played back or executed. When the selected object is a photograph in a gallery, a slide show may be performed.

Referring to FIG. 6B, at operation 631, the processor 210 of the electronic device 201 displays a piece of content for geo-fencing on the display module 260. In the following description, a specific region selected by user input is referred to as, but not limited to, a geofence area (e.g. a photograph in a gallery application of FIG. 4B, a file in a file manager application of FIG. 4C, and a word or term in a document handling application of FIG. 4C). In the case of a map application, the content may include various objects on the map, such as a building, road, river, and park. The map provided by the electronic device 201 may reflect characteristic properties of a specific geographic area (e.g. demarcation by buildings or roads), and the user may distinguish between a building and an unnecessary area on the basis of the characteristic properties.

At operation 633, the processor 210 senses user input on an object of the content on the map. Here, user input may include finger touch, pen touch, pen hovering, hand hovering, and pressure-sensitive touch. The processor 210 may detect user input on the display module 260 configured to sense user input.

At operation 635, the processor 210 configures a specific region including the object associated with the user input as a geofence area. For example, when user input is associated with a building on the map, the processor 210 may configure the entire building as a geofence area. The processor 210 may also configure a part or floor of the building as a geofence area. The processor 210 may identify the location of the building on the basis of GPS-based location information, information on the nearby base station and Wi-Fi AP, and signal strength information. The processor 210 may configure a part of the building (e.g. floor, or internal place) as a geofence area on the basis of the identified location information.

At operation 637, the processor 210 measures the level of pressure applied by the user input. The electronic device 201 may include the panel 262 of the display module 260 and the touch panel 252 of the input unit 250. The electronic device 201 may also include a pressure sensor to measure the level of pressure applied by user input. Upon sensing user input, the processor 210 may use the pressure sensor to measure the level of pressure applied by the user input. For example, the processor 210 may identify the x and y coordinates of the user input and identify the z coordinate (i.e. the level of applied pressure) of the user input through the pressure sensor. The processor 210 may measure the level of pressure applied by user input on the basis of the x, y and z coordinates and may distinguish between a light press and a deep press on the basis of the measured level of pressure.

At operation 639, the processor 210 changes the size of the geofence area according to the measured level of pressure. That is, the processor 210 may increase or decrease the size of the geofence area. For example, the processor 210 may measure the level of pressure applied by user input, and increase or decrease the size of the geofence area when the measured level of pressure matches a preset reference value. The processor 210 may also determine the speed of expansion or reduction of the geofence area on the basis of the measured level of pressure. Alternatively, the processor 210 may also determine the speed of expansion or reduction of the geofence area according to the time required for the increasing level of pressure to reach the reference value.

At operation 641, the processor 210 reconfigures the geofence area according to the changed size. Thereafter, the processor 210 may monitor another electronic device entering or leaving the reconfigured geofence area. The processor 210 may configure more than one geofence area.

FIG. 6C is a flowchart for describing operations performed after operation 639 of FIG. 6B. Referring to FIG. 6C, at operation 651, the processor 210 of the electronic device 201 may change the size of the geofence area. That is, operation 651 of FIG. 6C is identical to operation 639 of FIG. 6B.

At operation 653, the processor 210 determine whether a restricted region (e.g. harmful place) is contained in the geofence area. Here, a restricted region may be a special region configured by the user or an off-limits place for the general public. For example, a bar or club closed to minors may be designated as a harmful place by parents, and such a harmful place may be a restricted region to be excluded from the geofence area. A river or sea on the map may also be a restricted region as an off-limits place.

If a restricted region is contained in the geofence area, at operation 653, the processor 210 reconfigures the geofence area so that the restricted region is excluded from the geofence area. For example, a building designated as a harmful place or an off-limits place such as a river or sea may be excluded from the geofence area.

If no restricted region is contained in the geofence area, at operation 657, the processor 210 reconfigures the geofence area according to the changed size.

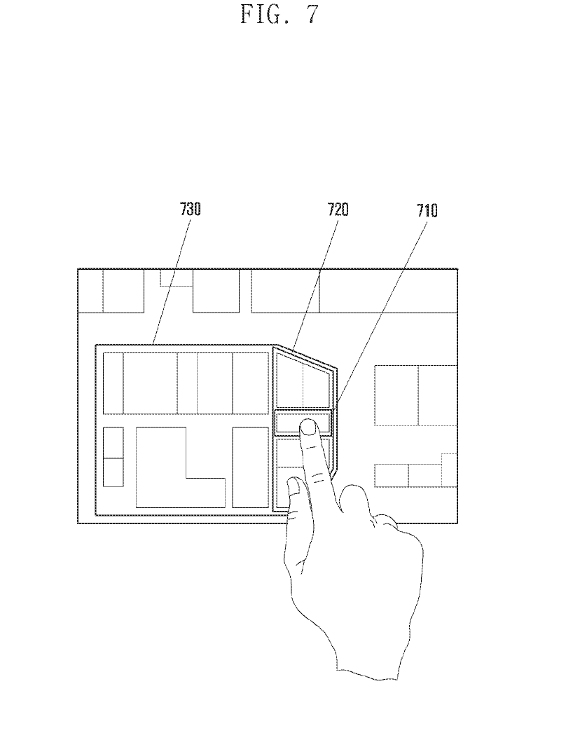

FIG. 7 illustrates modification of a geofence area on the basis of the level of pressure applied by user input.

FIG. 7 shows a map of a specific geographic area. Such a map may be provided by a map application installed in the electronic device 201. The map may include multiple objects such as a building, road, river, and sea. The processor 210 of the electronic device 201 may display a map on the display module 260. The processor 210 may sense user input on the displayed map. Upon sensing user input on an object 710 (e.g. building), the processor 210 may configure the object 710 as a geofence area. Here, the processor 210 may examine the attribute of the object associated with user input and configure a geofence area on the basis of the attribute of the object. For example, when the object is a restaurant, the processor 210 may configure both the restaurant and nearby restaurants thereof as a geofence area. In addition, the processor 210 may measure the level of pressure applied by the user input. The processor 210 may sense multiple levels of pressure for user input. For example, when the measured level of pressure is higher than a first reference value, the processor 210 may expand the geofence area to a first-stage range 720. When the measured level of pressure is higher than a second reference value, the processor 210 may expand the geofence area to a second-stage range 730. The staged ranges of a geofence may be configured according to the attribute or property of an object associated with user input. The range of a geofence may be set on the basis of the category to which the selected object belongs. For example, when the selected object is a restaurant, the first-stage range of the geofence may include the restaurant and nearby restaurants thereof. In various embodiments, the processor 210 of the electronic device 201 may sense touch input of the user, measure the level of pressure applied by the touch input, and change the size of a geofence area according to the measured level of pressure.

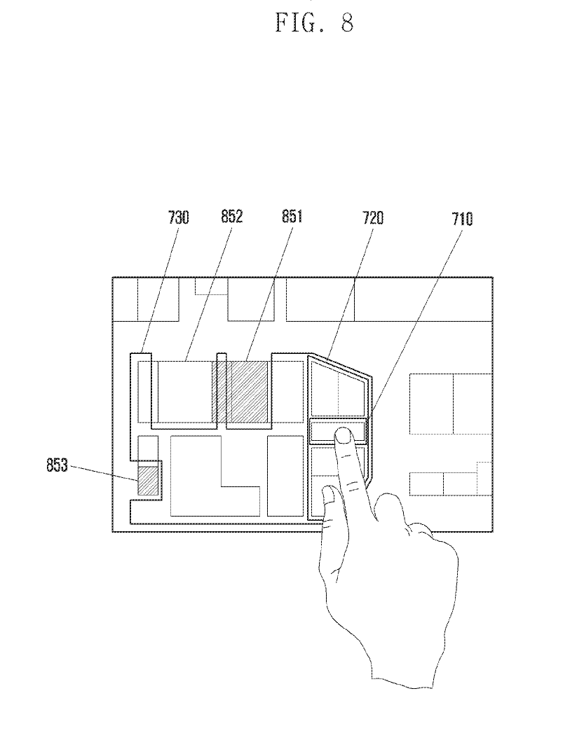

FIG. 8 illustrates modification of a geofence area by excluding an object designated as a restricted region.

Referring to FIG. 8, the processor 210 of the electronic device 201 may display a geographic map containing restricted regions 851, 852 and 853. Here, the restricted region 851, 852 or 853 may be a special object configured by the user or an off-limits place for the general public, such as a river or sea. Several restricted regions may be grouped as a single entity. For example, multiple bars or clubs closed to minors may be designated as a single restricted region. When at least one restricted region is included in a geofence area, the processor 210 may reconfigure the geofence area so that the restricted region is excluded from the geofence area.

As shown in FIG. 8, when at least one restricted region is included in the geofence area during expanding the geofence range, the processor 210 may reconfigure the geofence area so that the restricted region is excluded from the geofence area.

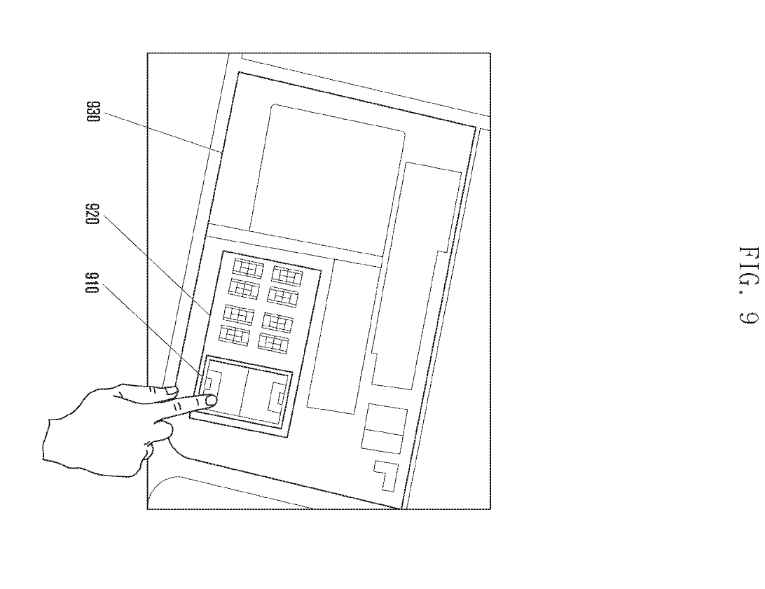

FIG. 9 illustrates modification of a geofence area with respect to a building or place.

Referring to FIG. 9, the processor 210 may display facilities on the display module 260. The facilities may include several buildings, a football field, and a tennis court. The processor 210 may sense user input on the football field, and may configure the region corresponding to the football field as a geofence area (first geofence range 910).

The processor 210 may measure the level of pressure applied by the user input and change the range of the geofence according to the measured level of pressure. For example, when the measured level of pressure is higher than a first reference value, the processor 210 may configure both the football field and the tennis court as the geofence area (second geofence range 920). When the measured level of pressure is higher than a second reference value, the processor 210 may configure all facilities related to the football field as the geofence area (third geofence range 930).

Here, the first reference value and the second reference value may be pre-stored in the memory 230 of the electronic device 201. The range of a geofence may be set on the basis of the attribute or property of an object selected by the user or on the basis of a geographic attribute. The range of the geofence may be changed by the user.

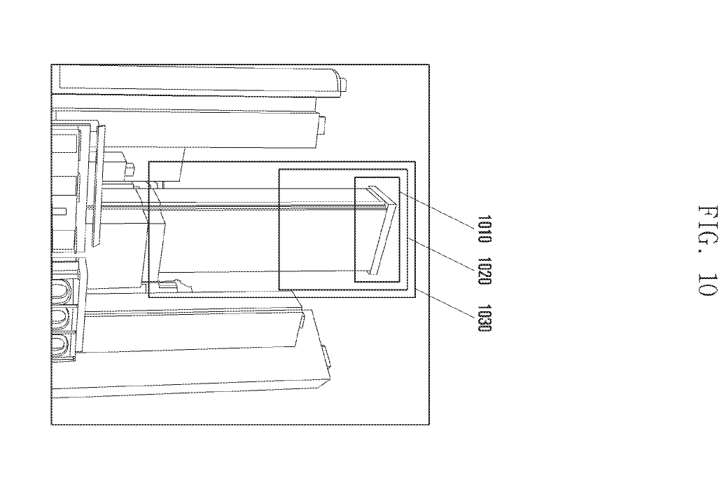

FIG. 10 illustrates modification of a geofence area with respect to both the horizontal direction and the vertical direction.

Referring to FIG. 10, the processor 210 may display exteriors of high-rise buildings on the display module 260. The processor 210 may configure a geofence on the basis of not only a horizontal map but also a vertically drawn figure. To configure a geofence in a high-rise building, the processor 210 may configure one or more floors of the high-rise building as a geofence. When user input is sensed on the topmost floor of the high-rise building, the processor 210 may configure the topmost floor as a geofence area (first geofence range 1010). The processor 210 may measure the level of pressure applied by the user input and change the geofence range according to the measured level of pressure. For example, when the measured level of pressure is higher than a first reference value, the processor 210 may expand the geofence area so that the geofence area includes the topmost floor and several floors near the topmost floor (second geofence range 1020). When the measured level of pressure is higher than a second reference value, the processor 210 may further expand the geofence area by a preset range (third geofence range 1030). The first reference value and the second reference value may be set by the user. The range for geofence expansion (e.g. floor count) may also be set by the user.

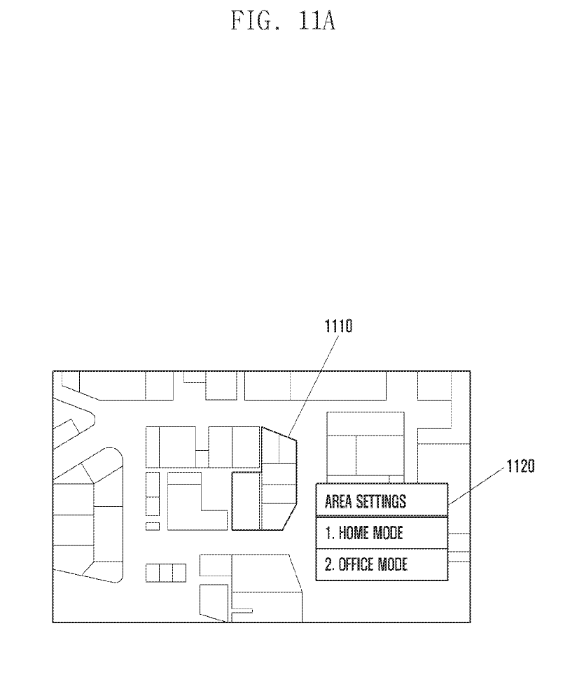

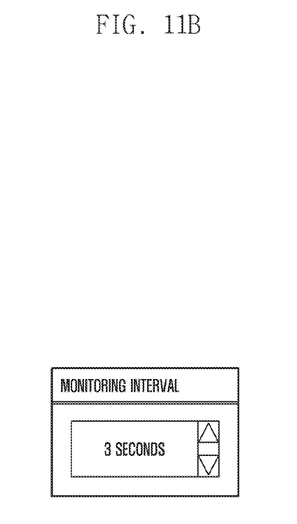

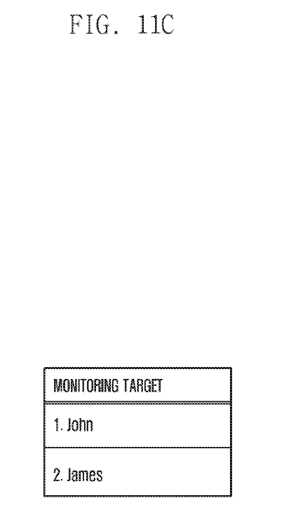

FIGS. 11A to 11C illustrate configuration settings for an electronic device entering a geofence area.

Referring to FIG. 11A, the processor 210 of the electronic device 201 may configure a geofence area 1110 according to user input. The processor 210 may also configure settings for the electronic device 201 entering or exiting the geofence area 1110. The processor 210 may output a setting window 1120 to define an operational mode for the electronic device 201 entering the geofence area 1110. For example, the setting window 1120 may provide options for home mode and office mode. In this case, when the electronic device 201 enters the geofence area 1110, the mode may switch to one of home mode and office mode. Although not shown, it is also possible to configure settings so that information on restaurants present in the geofence area 1110 is displayed on the screen when the electronic device 201 enters the geofence area 1110. Referring to FIG. 11B, the processor 210 may set a monitoring interval (or frequency) to monitor other electronic devices entering the geofence area 1110. For example, when the monitoring interval is set (in seconds), the electronic device 201 may monitor whether another electronic device enters the geofence area 1110 once for each monitoring interval. Referring to FIG. 11C, the processor 210 may specify one or more electronic devices to be tracked. For example, after configuring a geofence area, the processor 210 may specify one or more target electronic devices (users) to be monitored and monitor whether the target electronic devices enter or leave the geofence area. As shown in FIG. 11C, the processor 210 may output a setting window for targets to be tracked. When a target electronic device (target user) enters or exits the geofence area, the processor 210 may notify the user of an entrance event or exit event.

In various embodiments, the electronic device 201 may configure a geofence area on the basis of the attribute or property of a selected object and configure function settings for handling an electronic device (electronic device 201 or another electronic device) entering or exiting the geofence area.

According to various embodiments of the present disclosure, a computer-readable storage medium may store a program implementing a method for area selection. When executed, the program may cause the processor of an electronic device to perform a process of displaying a piece of content on a display module, sensing user input on a region of the content, measuring the level of pressure applied by the user input, selecting, when the measured level of pressure matches a first reference value, a first range of the content, selecting, when the measured level of pressure matches a second reference value, a second range of the content, and displaying an indication to the selected one of the first range and the second range on the display module.

According to various embodiments of the present disclosure, a computer-readable storage medium may store a program implementing a method for area selection. When executed, the program may cause the processor of an electronic device to perform a process of displaying a piece of content on a display module, sensing user input on a region of the content, examining the attribute or property of an object associated with the user input, selecting a specific range of the content on the basis of the attribute or property of the object, and displaying an indication to the selected range of the content on the display module.

In a feature of the present disclosure, the electronic device using the area selection method may sense user input. Upon sensing user input, the electronic device may measure the level of pressure corresponding to the user input and select an area (e.g. geofence area) on the basis of the measured level of pressure. The present disclosure provides a mechanism for area selection in accordance with the intention of the user. In other words, the level of pressure corresponding to user input may be measured and a desired area may be selected on the basis of the measured level of pressure without multi-stage actions. Hence, it is possible to enhance user convenience.

At least part of the method (e.g., operations) or system (e.g., modules or functions) according to various embodiments can be implemented with instructions as programming modules that are stored in computer-readable storage media. One or more processors (e.g., processor 120) can execute instructions, thereby performing the functions. An example of the computer-readable storage media may be a memory 130. At least part of the programming modules can be implemented (executed) by a processor. At least part of the programming module may include modules, programs, routines, sets of instructions or processes, etc., in order to perform one or more functions.

Examples of computer-readable media include: magnetic media, such as hard disks, floppy disks, and magnetic tape; optical media such as Compact Disc Read Only Memory (CD-ROM) disks and Digital Versatile Disc (DVD); magneto-optical media, such as floptical disks; and hardware devices that are specially configured to store and perform program instructions (e.g., programming modules), such as read-only memory (ROM), random access memory (RAM), flash memory, etc. Examples of program instructions include machine code instructions created by assembly languages, such as a compiler, and code instructions created by a high-level programming language executable in computers using an interpreter, etc. The described hardware devices may be configured to act as one or more software modules in order to perform the operations and methods described above, or vice versa.

Modules or programming modules according to various embodiments may include one or more components, remove part of them described above, or include new components. The operations performed by modules, programming modules, or the other components, according to various embodiments, may be executed in serial, parallel, repetitive or heuristic fashion. Part of the operations can be executed in any other order, skipped, or executed with additional operations.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An electronic device comprising:
a display configured to display a content and to receive user input;
a sensor configured to measure a level of pressure applied by the user input; and
a processor functionally connected with the display, wherein the processor is configured to perform a process that comprises:
displaying the content on the display,
measuring the level of pressure applied by the user input on a region of the content on the display using the sensor,
in response to the measured level of pressure being a first value, selecting a first range of the content,
in response to the measured level of pressure being a second value, selecting a second range of the content, and
displaying an indication to the selected first range or second range on the display.

2. The electronic device of claim 1, wherein the content includes map information, and wherein the processor is configured to select one of the first range or the second range on the basis of at least one of a height, type, or unit size of an object on the map.

3. The electronic device of claim 2, wherein the processor is configured to designate the selected range as a geofence area.

4. The electronic device of claim 1, wherein the content includes text data, and wherein the processor is configured to select one of the first range or the second range on the basis of at least one of a word, phrase, sentence, paragraph, or page in the text data.

5. The electronic device of claim 1, wherein the content includes at least one image, and wherein the processor is configured to select at least one of the first range or the second range on the basis of at least one of a person, place, background, composition, or color in the image.

6. The electronic device of claim 1, further comprising a memory configured to store at least one reference value, and wherein the processor is configured to determine whether the measured level of pressure is a first value or a second value by comparing the measured level of pressure with the stored at least one reference value.

7. The electronic device of claim 1, wherein the processor is configured to select one of the first range or the second range on the basis of at least one of an attribute or property of an object in the content.

8. The electronic device of claim 1, wherein the processor is configured to:
determine whether a restricted region is contained in the selected range; and
in response to the restricted region being contained in the selected range, display an indication to exclude the restricted region from the selected range through the display.

9. A method for an electronic device, the method comprising:
displaying a piece of content on a display;
sensing user input on a region of the content;
measuring a level of pressure applied by the user input;
in response to the measured level of pressure being a first value, select a first range of the content;
in response to the measured level of pressure being a second value, select a second range of the content; and
displaying an indication to the selected first range or second range on the display.

10. The method of claim 9, wherein selecting the first range or the second range comprises selecting, in response to the content being map content, one of the first range or the second range on the basis of at least one of a height, type, or unit size of an object on the map.

11. The method of claim 10, further comprising designating the selected range as a geofence area.

12. The method of claim 9, wherein selecting the first range or the second range comprises selecting, in response to the content being text data, one of the first range or the second range on the basis of at least one of a word, phrase, sentence, paragraph, or page in the text data.

13. The method of claim 9, wherein selecting the first range or the second range comprises selecting, in response to the content including at least one image, one of the first range or the second range on the basis of at least one of a person, place, background, composition, or color in the image.

14. The method of claim 9, wherein selecting the first range or the second range comprises selecting one of the first range or the second range on the basis of an attribute or property of an object in the content.

15. The method of claim 9, wherein the first range and the second range are set in advance on the basis of a region of the content.

16. An electronic device comprising:
a display configured to display a content and to receive user input;
a sensor configured to measure a level of pressure applied by the user input; and
a processor functionally connected with the display, wherein the processor is configured to perform a process that comprises:
displaying the content on the display,
measuring the level of pressure applied by the user input on a region of the content on the display using the sensor,
in response to the measured level of pressure being a first value, selecting a first range of the content on the basis of an attribute or property of an object in the region of the content,
in response to the measured level of pressure being a second value, selecting a second range of the content on the basis of the attribute or property of the object in the region of the content, and
displaying an indication to the selected first range or second range on the display.

17. The electronic device of claim 16, wherein the content includes map information, and wherein the processor is configured to select one of the first range or the second range on the basis of at least one of a height, type, or unit size of an object on the map and designate the selected range as a geofence area.

18. The electronic device of claim 16, wherein the content includes text data, and wherein the processor is configured to select one of the first range or the second range on the basis of at least one of a word, phrase, sentence, paragraph, or page in the text data.

19. The electronic device of claim 16, wherein the content includes at least one image, and wherein the processor is configured to select one of the first range or the second range on the basis of at least one of a person, place, background, composition, or color in the image.

20. The electronic device of claim 16, wherein the processor is configured to:
determine whether a restricted region is contained in the selected range; and
in response to the restricted region being contained in the selected range, display an indication to exclude the restricted region from the selected range through the display.
